(19) United States
(12) Patent Application Publication
(10) Pub. No.: US 2026/0342219 A1
(43) Pub. Date: Oct. 29, 2026

(54) AC-DC CONVERTER, ROTARY MACHINE DRIVER, AND REFRIGERATION CYCLE APPLIED EQUIPMENT

(71) Applicant: MITSUBISHI ELECTRIC CORPORATION, Tokyo (JP)

(72) Inventor: Kengo KAWAUCHI, Tokyo (JP)

(73) Assignee: MITSUBISHI ELECTRIC CORPORATION, Tokyo (JP)

(21) Appl. No.: 19/485,302

(22) PCT Filed: Feb. 21, 2024
(86) PCT No.: PCT/JP2024/006339

§ 371 Date: Nov. 18, 2025

(30) Foreign Application Priority Data
Jun. 12, 2023 (JP) 2023-096271

(51) Int. Cl. H02M 1/42; H02M 7/217

(52) U.S. Cl. CPC H02M 1/4208; H02M 7/217

(57) ABSTRACT

An AC-DC converter includes: a rectifier circuitry that rectifies power supply voltage applied from an AC power supply, the rectifier circuitry including a switching element; a capacitor that smooths output voltage of the rectifier circuitry, the capacitor being connected to a DC bus; a reactor disposed closer to the AC power supply than the capacitor; a current detector that detects power supply current flowing between the AC power supply and the rectifier circuitry; and a controller that generates a switching signal for controlling the switching element. The controller generates the switching signal in such a way as to change a phase of the power supply current.

### FIELD

The present disclosure relates to: an AC-DC converter that converts AC power into desired DC power; and a rotary machine driver and a refrigeration cycle applied equipment that include the AC-DC converter.

### BACKGROUND

When DC voltage is obtained from an AC power supply, a power factor correction circuit is generally used. The power factor correction circuit has a function of controlling bus voltage in such a way as to keep the bus voltage at a constant level and a function of controlling power supply current such that the power supply current can conform to the harmonic standard. A power factor correction circuit and a “simple switching method” (also referred to as a “partial switching method”), which is a type of control method for the power factor correction circuit, are based on a method in which switching is performed at least once in a half cycle of power supply voltage that is the voltage of an AC power supply, and are characterized in that bus voltage can be controlled such that the bus voltage is lower than a peak value of the power supply voltage. However, when the bus voltage is set to a value lower than the peak value of the AC power supply by the simple switching method, an operation circuit is switched from a boost chopper to a capacitor input type diode rectifier, leading to distortion of power supply current. This is a problem with the simple switching method.

In order to address this problem, the conventional technique disclosed in Patent Literature 1 below achieves a desired control regarding whether a combination of reactor capacity and switching timing can conform to the harmonic standard, by repeating design for each load power.

### CITATION LIST

### Patent Literature

Patent Literature 1: Japanese Patent Application Laid-open No. 2000-125545

### SUMMARY OF INVENTION

### Problem to be Solved by the Invention

However, since the conventional technique described in Patent Literature 1 is a method in which conformity with the harmonic standard is checked by repeated trials, the technique has a problem in that the number of trials increases exponentially as the number of pulses increases. In addition, the conventional technique described in Patent Literature 1 also has a problem in that since guidelines for quantitatively and uniquely designing control gain are not clear, it takes a lot of time to complete control gain design.

The present disclosure has been made in view of the above, and an object of the present disclosure is to shorten a time required for design by obtaining an AC-DC converter that achieves conformity with the harmonic standard without relying on trial-and-error adjustment.

### Means to Solve the Problem

In order to solve the above-described problems and achieve the object, an AC-DC converter according to the present disclosure includes: a rectifier circuitry; a capacitor; a reactor; a current detector; and a controller. The rectifier circuitry includes at least one switching element, and rectifies power supply voltage applied from an AC power supply. The capacitor is connected to a DC bus, and smooths output voltage of the rectifier circuitry. The reactor is disposed closer to the AC power supply than the capacitor. The current detector detects power supply current flowing between the AC power supply and the rectifier circuitry. When generating a switching signal for controlling the switching element disposed closer to the AC power supply than the capacitor, the controller generates the switching signal in such a way as to change the phase of the power supply current.

### Effects of the Invention

The AC-DC converter according to the present disclosure achieves conformity with the harmonic standard without relying on trial-and-error adjustment. Thus, the AC-DC converter according to the present disclosure has the effect of shortening the time required for designing.

### BRIEF DESCRIPTION OF DRAWINGS

FIG. 1 is a block diagram illustrating an exemplary configuration of a rotary machine driver according to a first embodiment.

FIG. 2 is a circuit diagram illustrating an exemplary configuration of an AC-DC converter according to the first embodiment.

FIG. 3 is a block diagram illustrating an exemplary configuration of a controller according to the first embodiment.

FIG. 4 is a block diagram illustrating an exemplary configuration of a sinusoidal signal generator included in the controller according to the first embodiment.

FIG. 5 is a diagram illustrating exemplary operation waveforms to be obtained when the AC-DC converter illustrated in FIG. 2 is passively operated.

FIG. 6 is a diagram illustrating exemplary operation waveforms to be obtained when the AC-DC converter illustrated in FIG. 2 is operated with a fundamental power factor=1.

FIG. 7 is a diagram illustrating exemplary operation waveforms to be obtained when phase shift control is performed on the AC-DC converter illustrated in FIG. 2.

FIG. 8 is a diagram illustrating an exemplary configuration of a refrigeration cycle applied equipment according to a second embodiment.

### DESCRIPTION OF EMBODIMENTS

Hereinafter, an AC-DC converter, a rotary machine driver, and a refrigeration cycle applied equipment according to embodiments of the present disclosure will be described in detail with reference to the accompanying drawings.

### First Embodiment

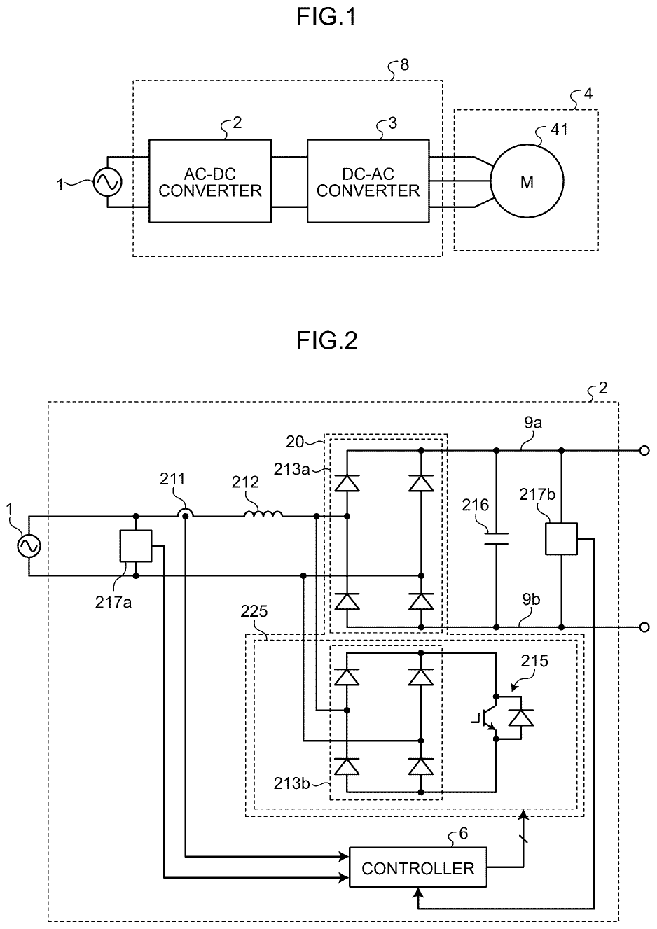

FIG. 1 is a block diagram illustrating an exemplary configuration of a rotary machine driver 8 according to a first embodiment. The rotary machine driver 8 is connected to an AC power supply 1 and a load 4 including a motor 41. The rotary machine driver 8 includes an AC-DC converter 2 and a DC-AC converter 3. When the rotary machine driver 8 is used for an air conditioner, the load 4 is a compressor or a fan, and the motor 41 is a compressor motor or a fan motor.

FIG. 2 is a circuit diagram illustrating an exemplary configuration of the AC-DC converter 2 according to the first embodiment. The AC-DC converter 2 according to the first embodiment includes, as main components, a controller 6, a rectifier circuitry 20, a reactor 212, and a capacitor 216. In addition, the AC-DC converter 2 includes a current detector 211 and voltage detectors 217a and 217b as voltage or current detection means. Note that, herein, when the voltage detectors 217a and 217b are distinguished from each other without reference numerals, the voltage detector 217b is referred to as a “first voltage detector”, and the voltage detector 217a is referred to as a “second voltage detector”.

The rectifier circuitry 20 includes: single-phase diode bridge cells 213a and 213b each including four diodes that are bridge-connected; and a switching element 215 that is connected in parallel to both ends of the single-phase diode bridge cell 213b. The single-phase diode bridge cells 213a and 213b are connected in parallel to each other with respect to the AC power supply 1. The rectifier circuitry 20 as illustrated in FIG. 2 is referred to as a “simple switching circuit”. The single-phase diode bridge cell 213b and the switching element 215 constitute a switching cell 225. The switching element 215 performs switching operation at least once in a half cycle of the power supply voltage.

The capacitor 216 is connected between a DC bus 9a and a DC bus 9b. The reactor 212 is disposed closer to the AC power supply than the capacitor 216. The rectifier circuitry 20 receives power supply voltage applied from the AC power supply 1 via the reactor 212, and rectifies the received power supply voltage. The capacitor 216 smooths output voltage of the rectifier circuitry 20.

The voltage detector 217b detects bus voltage which is voltage of the DC bus to which the capacitor is connected. The voltage detector 217a detects power supply voltage. The current detector 211 detects power supply current flowing between the AC power supply 1 and the rectifier circuitry 20.

Each of detection values of the voltage detectors 217a and 217b, and the current detector 211 is input to the controller 6. The controller 6 generates a switching signal for controlling the turning on and off of the switching element 215 on the basis of each detection value.

An example of the switching element 215 is the insulated gate bipolar transistor (IGBT) illustrated in the drawing, but is not limited to the IGBT. Any element may be used as the switching element 215 as long as switching operation can be performed. Another example of the switching element 215 is a metal-oxide-semiconductor field-effect transistor (MOSFET).

In addition, although the AC-DC converter 2 illustrated in FIG. 2 is configured as a closed loop in which the respective detection values of the voltage detectors 217a and 217b and the current detector 211 are used, the AC-DC converter 2 may be configured as an open loop in which a target value, an estimated value, and the like are used. In a case where the AC-DC converter 2 is configured as an open loop, it is possible to control the switching element 215 without using the respective detection values of the voltage detectors 217a and 217b and the current detector 211.

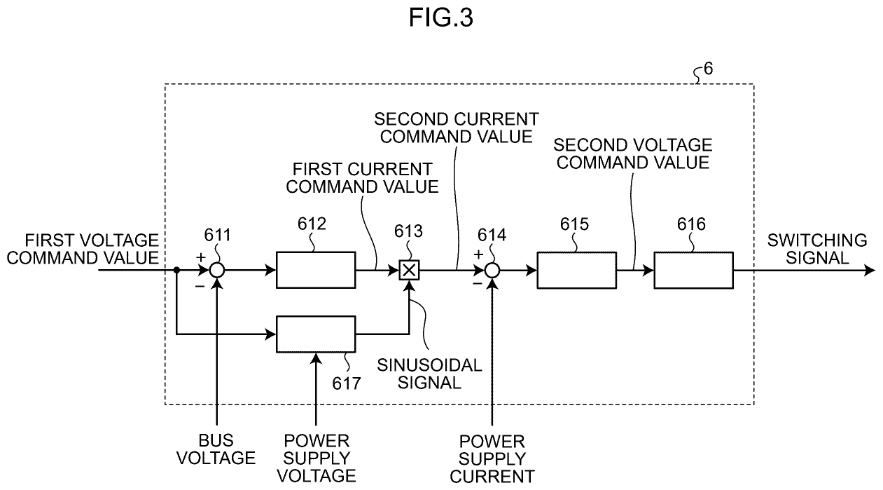

FIG. 3 is a block diagram illustrating an exemplary configuration of the controller 6 according to the first embodiment. The controller 6 includes: a subtracter 611; a voltage controller 612; a multiplier 613; a subtracter 614; a current controller 615; a switching signal generator 616; and a sinusoidal signal generator 617.

The subtracter 611 generates a voltage deviation that is a difference between a first voltage command value and a detection value of the bus voltage detected by the voltage detector 217b. The first voltage command value is a command value of the bus voltage. The voltage controller 612 generates a first current command value by using the voltage deviation output from the subtracter 611. The voltage controller 612 may be configured as, for example, a proportional integral (PI) controller.

In a case where the voltage controller 612 is configured as a PI controller, a transfer function G_{AVR(s)} can be expressed by formula (1) below.

$$\begin{matrix}Formula 1 & \\ {G}_{AVR ( s )} = {K}_{pAVR} + \frac{{K}_{iAVR}}{s} & ( 1 )\end{matrix}$$

Here, the symbol “AVR” in the transfer function G_{AVR(s)} is an abbreviation of an “automatic voltage regulator”. Furthermore, in formula (1) above, the symbol “K_{pAVR}” denotes proportional gain, the symbol “K_{iAVR}” denotes integral gain, and the symbol “s” is a Laplace operator. The proportional gain K_{pAVR} and the integral gain K_{iAVR} can be freely determined in the PI controller. Note that the voltage controller 612 may be configured as an I controller with the proportional gain K_{pAVR} set to zero, or may be configured as a P controller with the integral gain K_{iAVR} set to zero.

The sinusoidal signal generator 617 generates a sinusoidal signal serving as an excitation signal based on the first voltage command value and a detection value of the power supply voltage. The multiplier 613 multiplies the first current command value by the sinusoidal signal. The sinusoidal signal is a sinusoidal wave synchronized with the phase of the power supply voltage. Output of the multiplier 613 is input to the subtracter 614 as a second current command value. The subtracter 614 generates a current deviation that is a difference between the second current command value and a detection value of the power supply current detected by the current detector 211. The current controller 615 generates a second voltage command value by using the current deviation output from the subtracter 614. The current controller 615 can be configured as, for example, a PI controller. The switching signal generator 616 generates a switching signal by using the second voltage command value.

In a case where the current controller 615 is configured as a PI controller, a transfer function G_{ACR(s)} can be expressed by formula (2) below.

$$\begin{matrix}Formula 2 & \\ {G}_{ACR ( s )} = {K}_{pACR} + \frac{{K}_{iACR}}{s} & ( 2 )\end{matrix}$$

Here, the symbol “ACR” in the transfer function G_{ACR(s)} is an abbreviation of an “automatic current regulator”. Furthermore, in formula (2) above, the symbol “K_{pACR}” denotes proportional gain, the symbol “K_{iACR}” denotes integral gain, and the symbol “s” is a Laplace operator. The proportional gain K_{pACR} and the integral gain K_{iACR} can be freely determined in the PI controller. Note that the current controller 615 may be configured as an I controller with the proportional gain K_{PACR} set to zero, or may be configured as a P controller with the integral gain K_{iACR} set to zero.

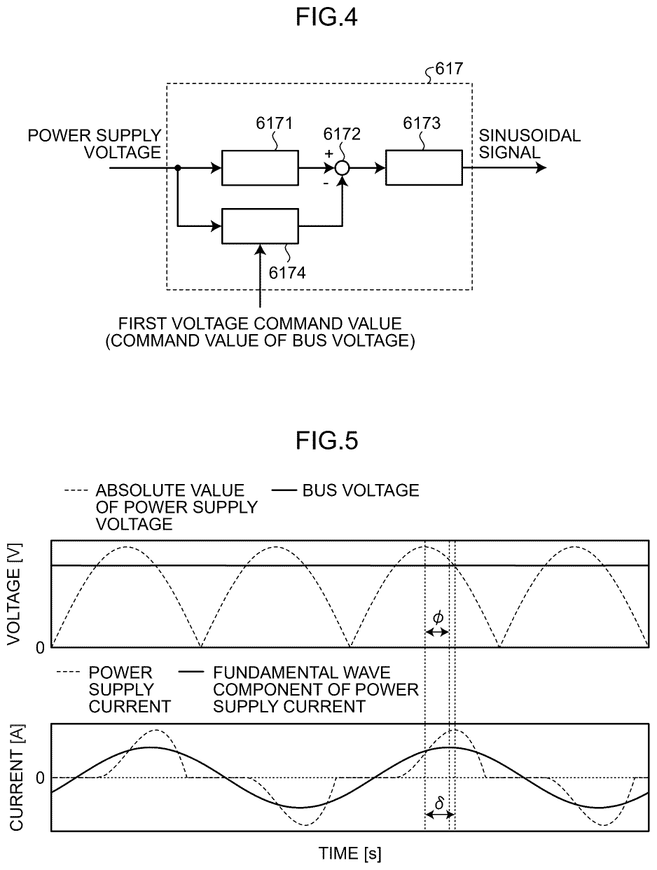

FIG. 4 is a block diagram illustrating an exemplary configuration of the sinusoidal signal generator 617 included in the controller 6 according to the first embodiment. The sinusoidal signal generator 617 outputs a sinusoidal wave synchronized with the phase of the power supply voltage and the frequency of the power supply voltage. In order to implement this function, the sinusoidal signal generator 617 includes: a phase-locked loop (PLL) calculator 6171; a subtracter 6172; a sinusoidal wave calculator 6173; and a phase shift amount calculator 6174.

The PLL calculator 6171 generates and outputs a sinusoidal phase synchronized with the phase and frequency of the power supply voltage. The phase shift amount calculator 6174 calculates a phase shift amount based on a detection value of the power supply voltage and the first voltage command value that is a command value of the bus voltage. The subtracter 6172 calculates a difference between the output of the PLL calculator 6171 and the output of the phase shift amount calculator 6174. The sinusoidal wave calculator 6173 calculates a sinusoidal signal by using the difference output from the subtracter 6172.

Next, a method for calculating a phase shift amount will be described with reference to several drawings and mathematical expressions.

FIG. 5 is a diagram illustrating exemplary operation waveforms to be obtained when the AC-DC converter 2 illustrated in FIG. 2 is passively operated. The passive operation refers to operation to be performed in a passive mode. The passive mode refers to a mode of operating the rectifier circuitry 20 without switching the switching element 215. In the upper part of FIG. 5, a waveform of the absolute value of the power supply voltage is indicated by a broken line, and a waveform of the bus voltage is indicated by a solid line. In the lower part of FIG. 5, a waveform of the power supply current is indicated by a broken line, and a waveform of a fundamental wave component of the power supply current is indicated by a solid line. The power supply current illustrated in the lower part is a detection waveform of the power supply current detected by the current detector 211.

In the passive mode, when the power supply voltage exceeds the bus voltage, current flows to excite the reactor 212. A current-flow start phase γ, which is a phase at which the current starts to flow, corresponds to an intersection point at which the power supply voltage rises to a voltage equal to the bus voltage, and thus is obtained by formula (3) below.

$$\begin{matrix}Formula 3 & \\ γ = {sin}^{- 1} ( \frac{{V}_{d c}}{\sqrt{2} {v}_{s}} ) & ( 3 )\end{matrix}$$

In formula (3) above, V_{dc} denotes the bus voltage, and vₛ denotes the effective value of the power supply voltage. The power supply current continues to increase until the power supply voltage crosses the bus voltage again. This intersection point corresponds to a peak value of the power supply current. A current peak phase φ, which is the phase of the peak value of the power supply current, can be expressed by formula (4) below with the peak value of the power supply voltage as a basis.

$$\begin{matrix}Formula 4 & \\ ϕ = \frac{π}{2} - {sin}^{- 1} ( \frac{{V}_{d c}}{\sqrt{2} {v}_{s}} ) & ( 4 )\end{matrix}$$

When the power supply voltage falls below the bus voltage, current decreases and finally becomes zero. Based on the above circuit operation, the power supply current has a schematic shape as indicated by the line in FIG. 5.

In addition, during the passive operation, the fundamental wave component of the power supply current has a waveform the phase of which is delayed with respect to the power supply voltage as illustrated in FIG. 5. Due to the characteristics exhibited during the passive operation, when the fundamental power factor is set to 1 under the condition that the bus voltage is equal to or less than the peak value of the power supply voltage, a low-order harmonic is superimposed on the power supply current. The reason is as follows. First, when the fundamental power factor is set to 1 during the passive operation, it is necessary to perform switching a plurality of times after zero crossing of the power supply voltage. Meanwhile, the power supply current is distorted in this switching control. Therefore, when the fundamental power factor is set to 1 under the condition that the bus voltage is equal to or less than the peak value of the power supply voltage, the power supply current is distorted, and the low-order harmonic is superimposed on the power supply current.

Therefore, in the control method herein, instead of setting the fundamental power factor to 1 under the condition that the bus voltage is equal to or less than the peak value of the power supply voltage, the phase of the sinusoidal signal that excites the first current command value is controlled such that the phase of the sinusoidal signal is synchronized with a fundamental wave phase of the power supply current during the passive operation. The current distortion caused by the fundamental wave control of the power supply current can be reduced in this manner. It is thus possible to suppress a harmonic component, which may be included in the power supply current, under the condition that the bus voltage is equal to or less than the peak value of the power supply voltage.

For calculation of the phase of the power supply current during the passive operation, it is conceivable to use a Fourier series expansion in which a time formula of the power supply current during the passive operation is established. However, in this method, a timing at which current becomes zero cannot be calculated by algebraic operation. Thus, calculation of a fundamental wave can be performed merely analytically. Therefore, a phase shift amount δ is approximately determined herein.

The phase shift amount δ is illustrated in the lower part of FIG. 5. The phase shift amount δ refers to a phase of the peak value of the power supply current based on the peak value of the power supply voltage. Meanwhile, the current peak phase φ described above is illustrated in the upper part of FIG. 5. The current peak phase φ refers to a phase of the peak value of the power supply current during the passive operation. Both the phase shift amount δ and the current peak phase φ are based on the peak value of the power supply voltage. In addition, as illustrated in FIG. 5, both are close to each other, and both have close values.

Therefore, here it is assumed that the phase shift amount δ is substantially equal to the current peak phase φ, and the phase shift amount δ is defined by formula (5) below.

$$\begin{matrix}Formula 5 & \\ δ \approx \frac{π}{2} - {sin}^{- 1} ( \frac{{V}_{d c}}{\sqrt{2} {v}_{s}} ) & ( 5 )\end{matrix}$$

Note that formula (5) above is an example, and the phase shift amount δ in the present specification is not limited only to formula (5) above.

The phase shift amount calculator 6174 outputs the phase shift amount δ generated based on formula (5) above to the subtracter 6172. When θᵥₛ denotes the sinusoidal phase output from the PLL calculator 6171, “θᵥₛ-δ” is input to the sinusoidal wave calculator 6173. Therefore, a sinusoidal signal f expressed by formula (6) below is output from the sinusoidal wave calculator 6173.

Formula 6:

f=sin(θᵥₛ−δ) (6)

The sinusoidal signal f is a signal that excites the first current command value. As the phase of the sinusoidal signal f is shifted, the phase of the power supply current is also shifted. Herein, this control is referred to as “phase shift control” as appropriate.

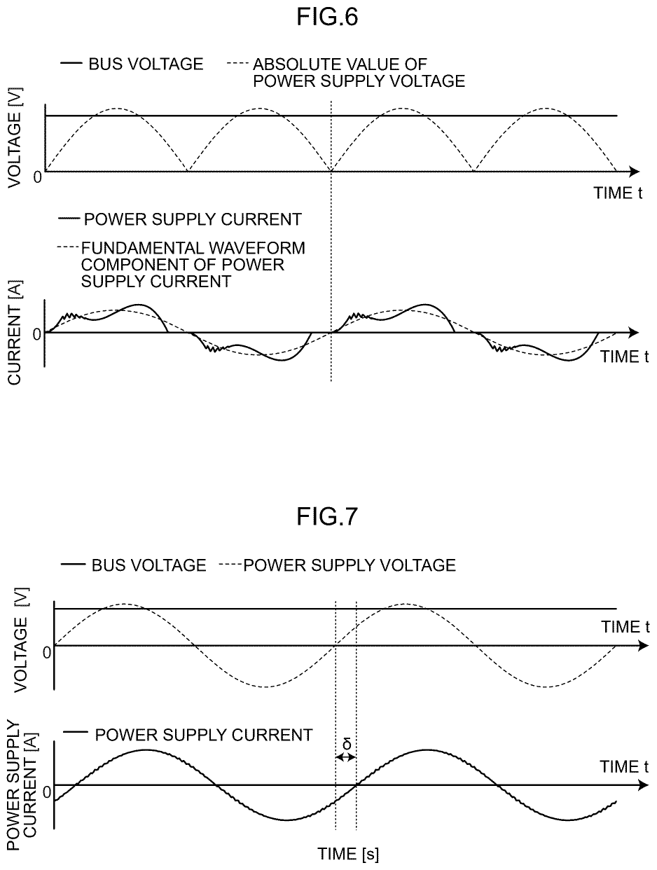

FIG. 6 is a diagram illustrating exemplary operation waveforms to be obtained when the AC-DC converter 2 illustrated in FIG. 2 is operated with the fundamental power factor=1. In the upper part of FIG. 6, a waveform of the absolute value of the power supply voltage is indicated by a broken line, and a waveform of the bus voltage is indicated by a solid line. In the lower part of FIG. 6, a waveform of the power supply current is indicated by a solid line, and a waveform of the fundamental wave component of the power supply current is indicated by a broken line.

As indicated by the solid line waveform in the lower part of FIG. 6, switching control on the switching element 215 is concentrated in a period from when the power supply voltage passes a zero-crossing point until the absolute value of the power supply voltage reaches the peak value. That is, when the fundamental power factor of the power supply current is set to 1 without using the phase shift control, the switching control on the switching element 215 is concentrated in a part of the period, and as a result, the power supply current is distorted.

FIG. 7 is a diagram illustrating exemplary operation waveforms to be obtained when the phase shift control is performed on the AC-DC converter 2 illustrated in FIG. 2. In the upper part of FIG. 7, a waveform of the absolute value of the power supply voltage is indicated by a broken line, and a waveform of the bus voltage is indicated by a solid line. In the lower part of FIG. 7, a waveform of the power supply current is indicated by a solid line.

Looking at the waveform in the lower part of FIG. 7, although a minute change in current is observed, the waveform of the power supply current itself changes in accordance with the waveform of the fundamental wave of the power supply current. Therefore, if the AC-DC converter 2 is operated by use of the phase shift control described in the present specification, the power supply current can be sinusoidally controlled. Therefore, by using the phase shift control described in the present specification, it is possible to operate the AC-DC converter 2 in conformity with the harmonic standard without relying on trial-and-error adjustment in which conformity with the harmonic standard is checked by repeated trials.

As described above, the AC-DC converter according to the first embodiment includes: a rectifier circuitry that rectifies power supply voltage applied from an AC power supply; a capacitor that smooths output voltage of the rectifier circuitry; a reactor disposed closer to the AC power supply than the capacitor; and a current detector that detects power supply current flowing between the AC power supply and the rectifier circuitry. The rectifier circuitry includes at least one switching element disposed closer to the AC power supply than the capacitor. When generating a switching signal for controlling the switching element, the controller generates the switching signal in such a way as to change the phase of the power supply current. According to the AC-DC converter of the first embodiment, the power supply current can be sinusoidally controlled. As a result, harmonic components included in the power supply current flowing between the AC power supply and the rectifier circuitry can conform to the harmonic standard without relying on trial-and-error adjustment. In addition, according to the AC-DC converter of the first embodiment, it is possible to conform to the harmonic standard while improving an input power factor even under the operating condition that the bus voltage is equal to or less than the peak value of the absolute value of the power supply voltage.

In order to implement the above function, the AC-DC converter according to the first embodiment includes a current detector that detects power supply current, and the controller generates a switching signal in such a way as to change a phase of the power supply current based on a fundamental wave of the power supply current detected when the switching element is turned off to cause the rectifier circuitry to be passively operated. By controlling the switching element of the rectifier circuitry by means of the switching signal generated in this manner, it is possible to sinusoidally control the power supply current. Therefore, even under the operating condition that the bus voltage is equal to or less than the peak value of the absolute value of the power supply voltage, it is possible to conform to the harmonic standard while improving the input power factor. Note that it is possible to generate such a switching signal by changing the phase of the power supply current according to a magnitude relationship between a detection value of the bus voltage detected by the first voltage detector and a detection value of the power supply voltage detected by the second voltage detector.

### Second Embodiment

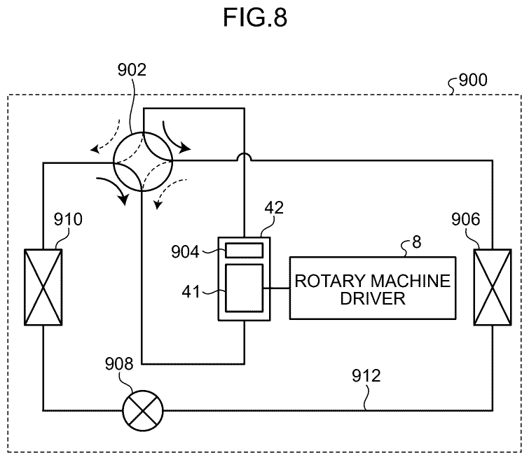

FIG. 8 is a diagram illustrating an exemplary configuration of a refrigeration cycle applied equipment 900 according to a second embodiment. The refrigeration cycle applied equipment 900 according to the second embodiment includes the rotary machine driver 8 described in the first embodiment. The refrigeration cycle applied equipment 900 according to the second embodiment can be applied to products having a refrigeration cycle, such as an air conditioner, a refrigerator, a freezer, and a heat pump water heater.

The refrigeration cycle applied equipment 900 includes: a compressor 42 including the motor 41 according to the first embodiment; a four-way valve 902; an indoor heat exchanger 906; an expansion valve 908; and an outdoor heat exchanger 910, which are installed via a refrigerant pipe 912. The compressor 42 includes the motor 41 in the first embodiment. Inside the compressor 42, the compression mechanism 904 that compresses a refrigerant, and the motor 41 that causes the compression mechanism 904 to operate are provided. The refrigeration cycle applied equipment 900 can perform heating operation or cooling operation according to switching operation of the four-way valve 902.

The compression mechanism 904 is driven by the motor 41 that is under variable speed control. During the heating operation, the refrigerant is pressurized by the compression mechanism 904 and delivered therefrom, passes through the four-way valve 902, the indoor heat exchanger 906, the expansion valve 908, the outdoor heat exchanger 910, and the four-way valve 902, and returns to the compression mechanism 904, as indicated by solid arrows. During the cooling operation, the refrigerant is pressurized by the compression mechanism 904 and delivered therefrom, passes through the four-way valve 902, the outdoor heat exchanger 910, the expansion valve 908, the indoor heat exchanger 906, and the four-way valve 902, and returns to the compression mechanism 904, as indicated by broken arrows. During the heating operation, the indoor heat exchanger 906 acts as a condenser to release heat, and the outdoor heat exchanger 910 acts as an evaporator to absorb heat. During the cooling operation, the outdoor heat exchanger 910 acts as a condenser to release heat, and the indoor heat exchanger 906 acts as an evaporator to absorb heat. The expansion valve 908 decompresses and expands the refrigerant.

The configurations set forth in the above embodiments show examples, and it is possible to combine the configurations with another known technique or combine the embodiments with each other, and is also possible to partially omit or change the configurations without departing from the scope of the present disclosure. For example, the control method described above is also applicable to a DC-AC converter.

### REFERENCE SIGNS LIST

1 AC power supply; 2 AC-DC converter; 3 DC-AC converter; 4 load; 6 controller; 8 rotary machine driver; 9a, 9b DC bus; 20 rectifier circuitry; 41 motor; 42 compressor; 211 current detector; 212 reactor; 213a, 213b single-phase diode bridge cell; 215 switching element; 216 capacitor; 217a, 217b voltage detector; 225 switching cell; 611, 614, 6172 subtracter; 612 voltage controller; 613 multiplier; 615 current controller; 616 switching signal generator; 617 sinusoidal signal generator; 900 refrigeration cycle applied equipment; 902 four-way valve; 904 compression mechanism; 906 indoor heat exchanger; 908 expansion valve; 910 outdoor heat exchanger; 912 refrigerant pipe; 6171 PLL calculator; 6173 sinusoidal wave calculator; 6174 phase shift amount calculator.

1. An AC-DC converter comprising:
a rectifier circuitry configured to rectify power supply voltage applied from an AC power supply, the rectifier circuitry including at least one switching element;
a capacitor configured to smooth output voltage of the rectifier circuitry, the capacitor being connected to a DC bus;
a reactor disposed closer to the AC power supply than the capacitor;
a current detector configured to detect power supply current flowing between the AC power supply and the rectifier circuitry; and
a controller configured to generate a switching signal for controlling the switching element, wherein
the switching element is disposed closer to the AC power supply than the capacitor, and
the controller is configured to generate the switching signal in such a way as to change a phase of the power supply current based on a fundamental wave of the power supply current detected when the switching element is turned off to cause the rectifier circuitry to be passively operated.

2. (canceled)

3. The AC-DC converter according to claim 1, comprising:
a first voltage detector configured to detect bus voltage that is voltage of the DC bus; and
a second voltage detector configured to detect the power supply voltage, wherein
the controller is configured to generate the switching signal in such a way as to change the phase of the power supply current according to a magnitude relationship between a detection value of the bus voltage and a detection value of the power supply voltage.

4. A rotary machine driver comprising the AC-DC converter according to claim 1.

5. A refrigeration cycle applied equipment comprising the AC-DC converter according to claim 1.

6. A rotary machine driver comprising the AC-DC converter according to claim 3.

7. A refrigeration cycle applied equipment comprising the AC-DC converter according to claim 3.
